(19) United States
(12) Patent Application Publication
(10) Pub. No.: US 2006/0221824 A1
(43) Pub. Date: Oct. 5, 2006

(54) Storage system and data processing method

(76) Inventor: Tomoya Anzai, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/144,667

(22) Filed: Jun. 6, 2005

(30) Foreign Application Priority Data
Apr. 4, 2005 (JP) 2005-107033

(51) Int. Cl. H04L 12/56; H04L 12/28; G01R 31/08; G08C 15/00; H04L 12/26; G06F 11/00; H04J 3/14; H04J 1/16; H04L 1/00

(52) U.S. Cl. 370/229; 370/389

(57) ABSTRACT

Proposed is a storage system and data processing method capable of effectively preventing the transfer delay or loss of important data or data which should be processed in real time. The priorities respectively set to each packet transmitted from the host system are detected, each packet is processed, and these processing results are packetized into a packet having the same priority as the priorities set to the packets, and this is transmitted to the host system. As a result, since the processing results of a packet having a high priority from the host system can be transmitted to the host system with the same priority, the transfer delay or loss of important data or data which should be processed in real time can be prevented effectively.

### CROSS-REFERENCES TO RELATED APPLICATIONS

This application relates to and claims priority from Japanese Patent Application No. 2005-107033, filed on Apr. 4, 2005, the entire disclosure of which is incorporated herein by reference.

### BACKGROUND OF THE INVENTION

1. Field of the Invention

The present invention relates to a storage system and data processing method and, for instance, is preferably used in NAS (Network Attached Storage).

2. Description of the Related Art

Needs of file sharing services using NAS are increasing year by year. Further, with a network system that provides such file sharing service, access to NAS tends to increase pursuant to the increase in the capacity of the files to be shared. Under these circumstances, there are cases where the processing of important data or data which should be processed in real time is delayed, or, in worst case scenarios, the data may be lost or it may not be possible to ensure the processing of such data in real time.

Thus, conventionally, as a method of transmitting important data or data which should be processed in real time in preference to other data, a method using the QoS (Quality of Service) function of routers of a peripheral network is used. Here, the QoS function of routers refers to the function of the router preferentially performing transfer processing to the packets having an attribute or having a priority by individually setting attributes such as the source address, destination address, port and so on in the router, or setting priorities in the packets as described later. Incidentally, the technology of setting priorities in the IP packet is described in Non-patent Document 1 indicated below.

RFC791, [online], [searched on Mar. 26, 2005], Internet <URL: http://www.faqs.org/rfcs/rfc791.html>

### SUMMARY OF THE INVENTION

Nevertheless, with the conventional method using this QoS function or the like of routers, packets are preferentially transferred on the network only in one direction; for instance, from the client terminal to NAS, and there is a problem in that the packet storing the processing result (reply) regarding such packet would be subject to the transfer delay or loss of data in the stage where it is transferred from NAS to the client terminal.

Further, according to this conventional method, since it is not possible to differentiate the importance of the packets received in NAS to process the packets, there was a possibility that the processing of important data or data which should be processed in real time would be delayed, or important data would be lost during high loads in NAS.

Moreover, according to this conventional method, since the setting of attributes of packets to be given a preference in transfer processing will be based on an IP level such as a source, destination address or in port units, there is a problem in that detailed settings in user units or the like cannot be made.

The present invention was devised in view of the foregoing problems, and proposed is a storage system and data processing method capable of effectively preventing the transfer delay or loss of important data or data which should be processed in real time.

The present invention for overcoming the foregoing problems is a storage system for packetizing and transmitting/receiving information with a host system, including: a first processing unit for detecting the priorities respectively set to each packet to be transmitted from the host system; a second processing unit for processing each of the packets; and a communication unit for packetizing the processing results of each of the packets into a packet having the same priority as the priorities set to the packets, and transmitting this to the host system.

Further, the present invention is also a data processing method in a storage system for packetizing and transmitting/receiving information with a host system, including: a first step for detecting the priorities respectively set to each packet to be transmitted from the host system; a second step for processing each of the packets; and a third step for packetizing the processing results of each of the packets into a packet having the same priority as the priorities set to the packet, and transmitting this to the host system.

According to the present invention, since the processing results of a packet having a high priority from the host system can be transmitted to the host system with the same priority, the transfer delay or loss of important data or data which should be processed in real time can be prevented effectively.

### BRIEF DESCRIPTION OF THE DRAWINGS

FIG. 1 is a block diagram showing the configuration of the network system according to the present embodiment;

FIG. 2 is a conceptual diagram explaining the data format of a packet to be transmitted and received in the network system illustrated in FIG. 1;

FIG. 3 is a block diagram explaining the function of NAS;

FIG. 4 is a timing chart explaining the processing flow inside NAS;

FIG. 5 is a conceptual diagram showing the session management table;

FIG. 6 is a conceptual diagram showing the TOS mapping table;

FIG. 7 is a flowchart showing the setting steps of the priority (precedence) and processing priority into the session management table according to the first embodiment;

FIG. 8 is a conceptual diagram explaining the scheduling with the scheduler according to the processing priority of the packet (section);

FIG. 9 is a flowchart explaining the scheduling with the scheduler according to the processing priority of the packet (section);

FIG. 10 is a conceptual diagram showing the priority list;

FIG. 11 is a flowchart showing the setting steps of the priority (precedence) and processing priority into the session management table according to the second embodiment; and

FIG. 12 is a flowchart showing the setting steps of the priority (precedence) and processing priority into the session management table according to the third embodiment.

### DETAILED DESCRIPTION OF THE PREFERRED EMBODIMENTS

Embodiments of the present invention are now described in detail with reference to the attached drawings.

### (1) First Embodiment

(1-1) Configuration of Network System According to Present Embodiment

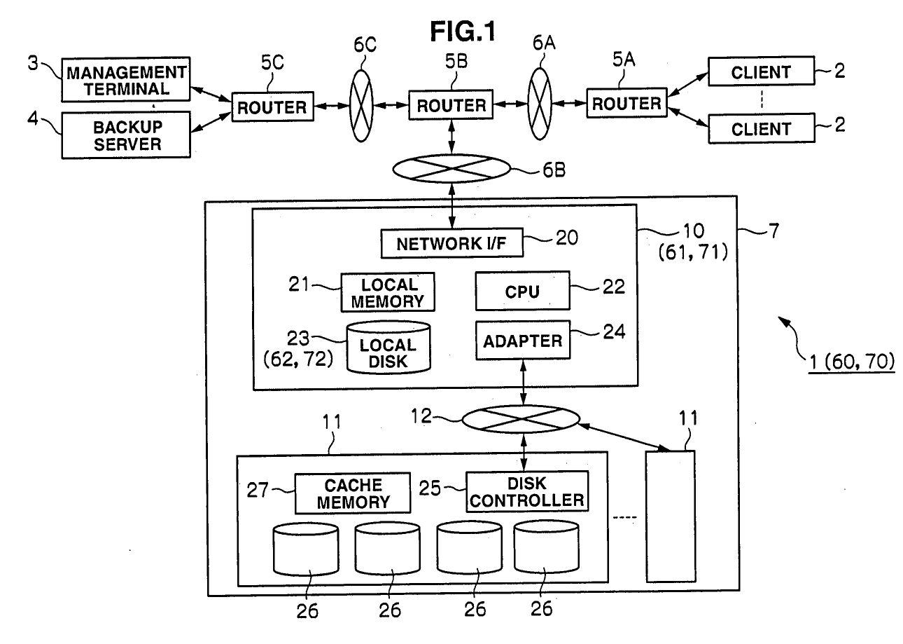

FIG. 1 is a diagram showing the network system 1 according to the present embodiment providing the file sharing service. This network system 1 is configured by the client terminals 2, as a plurality of host systems, being connected to the NAS 7 sequentially via a first router 5A, a first network 6A, a second router 5B and a second network 6B, as well as a management terminal 3 also as the host system and a backup server 4 being connected to the storage system 7 sequentially via a third router 5C, a third network 6C, a second router 5B and a second network 6B.

Each client terminal 2 is a computer equipped with the likes of a CPU (Central Processing Unit) and memory. Various functions are realized by the CPU of the client terminal 2 executing various programs. The client terminal 2, for example, is constituted from the likes of a personal computer, workstation or mainframe computer.

The management terminal 3 is also a computer equipped with the likes of a CPU and memory. Various functions are realized by the CPU of the management terminal 3 executing various programs. This management terminal 3, for instance, is used for the maintenance management of the storage system 7 such as setting the access right to the storage system 7 or instructing the creation of a new file system. This management terminal 3, for example, is also constituted from the likes of a personal computer, workstation or mainframe computer.

The backup server 4, for instance, is constituted from a large-capacity storage apparatus of a disk array device. Various functions including the automatic backup are realized by the CPU of the backup server 4 executing various programs.

The first to third routers 5A to 5C have a data transfer function for transferring a packet to its destination based on the destination address contained in the IP header of such received packet. The packet of the I/O request or write target data to be output from the client terminal 2, and the packet of various command to be output from the management terminal 3 and backup server 4 are transferred to the storage system 7 via the first to third networks 6A to 6C based on the data transfer function of these first to third routers 5A to 5C. Meanwhile, the packet of the various commands to be output from the storage system 7 or the data read out from the storage system 7 is transferred to the corresponding client terminal 2, management terminal 3 or backup server 4 via the third to first networks 5C to 5A based on the data transfer function of these first to third routers 5A to 5C.

Further, the first to third routers 5A to 5C have a QoS function for preferentially performing transfer processing to a packet with high priority based on the priority (“precedence” described later) set in the IP header of the packet as described later. Thereby, with this network system 1, by setting a priority in a packet to be transmitted from the client terminal 2, management terminal 3 or backup server 4 to the storage system 7, or in a packet to be transmitted from the storage system 7 to the client terminal 2, management terminal 3 or backup server 4, such packet can be transmitted to the storage system 7 or the client terminal 2, management terminal 3 or backup server 4 in preference to the other packets.

The first to third networks 6A to 6C are constituted from a LAN (Local Area Network), SAN (Storage Area Network), Internet, dedicated line, public line or the like. Data communication via the LAN is conducted, for example, according to the TCP/IP (Transmission Control Protocol/Internet Protocol) protocol. Further, communication via a SAN is conducted according to a fiber channel protocol. When the first to third networks 6A to 6C are a LAN, the client terminal 2, management terminal 3 and backup server 4 transmit to the storage system 7 the data I/O request in file units designating the file name. Meanwhile, when the first to third networks 6A to 6C is a SAN, the client terminal 2, management terminal 3 and backup server 4 transmit to the storage system 7 the data I/O request in block units according to the fiber channel protocol. Here, a block is the management unit of data in the storage area in the storage system 7. Incidentally, in the following explanation, the first to third networks 6A to 6C are a LAN, and the communication between the client terminal 2, management terminal 3 or backup server 4 and the storage system 7 will be conducted according to the TCP/IP protocol.

The storage system 7 is configured from a NAS 10 with a file system function, and a plurality of disk sub systems 11 connected to this NAS 10 via a fourth network 12.

The NAS 10 is configured from a network interface 20 connected to a third network 6B, a local memory 21 formed from the likes of an nonvolatile memory, a CPU 22 for controlling the overall NAS 10, a plurality of local disks 23 formed from the likes of a hard disk device, and an adapter 24 as an interface for communicating with the respective disk sub systems 11 via the fourth network 12.

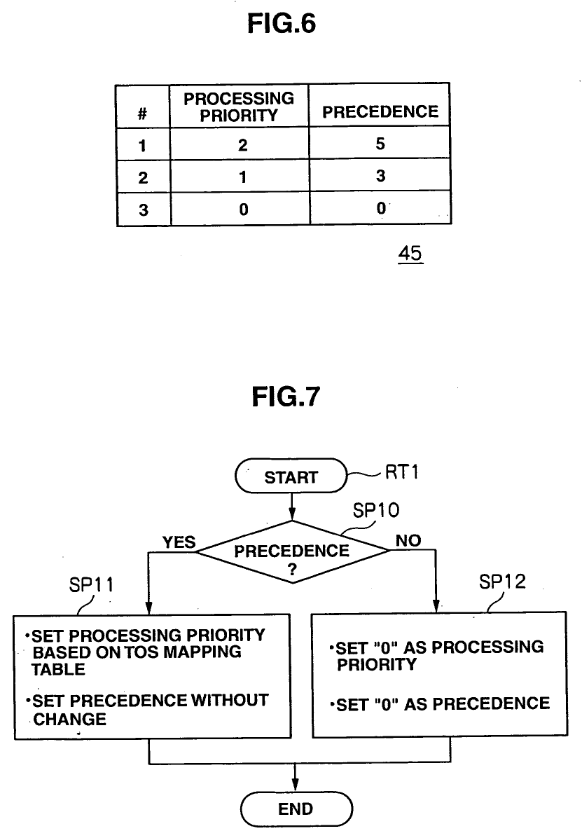

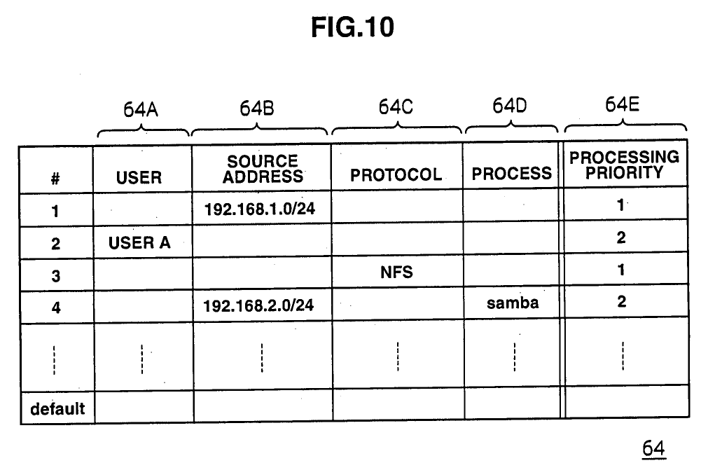

The local disk 23 stores various programs, management information for managing the storage area provided by the respective disk sub systems 11 and the data stored in such storage area, and various data such as the TOS (Type of Service) mapping table 45 (FIG. 6) and priority list 64 (FIG. 10) described later. The CPU 22 reads the program stored in these local disks 23 and stores it in the local memory 21. Then, the CPU 22 executes the program stored in this local memory 21 to perform various processing according to requests from the client terminal 2, management terminal 3 or backup server 4.

For example, when the CPU 22 receives the data I/O request from the client terminal 2 via the network interface 20, it creates a corresponding data I/O request, and transmits this to the corresponding disk sub system 11 via the adapter 24 and fourth network 12. Further, when the data I/O request from the client terminal 2 is a write request, the CPU 22 transmits the data of the write target transmitted from the client terminal 2 together with this data I/O request to the corresponding disk sub system 11. Further, when the data I/O request from the client terminal 2 is a read request, the CPU 22 transmits the data read from the corresponding disk sub system 11 to the corresponding client terminal 2 via the network interface 20.

Further, when the CPU 22 receives various commands from the management terminal 3 via the network interface 20, it executes corresponding processing such as various settings according to this command. Moreover, when the CPU 22 receives a backup data transfer request from the backup server 4 via the network interface 20, it transmits the data I/O request (readout request) to the corresponding disk sub system 11 via the adapter 24, and transmits the backup data obtained as a result to the backup server 4 via the network interface 20.

The fourth network 12, for example, is configured from a SAN. However, the configuration is not limited thereto, and a LAN or dedicated line may also be used. When the fourth network 12 is a SAN, the communication between the NAS 10 and the respective disk sub systems 11 via this fourth network 12 will be conducted according to the fiber channel protocol. Moreover, when the fourth network 12 is a LAN, the communication between the NAS 10 and the respective disk sub systems 11 via this fourth network 12 will be conducted according to the TCP/IP protocol.

Each of the disk sub systems 11 is configured by including a disk controller 25 of a computer configuration having a CPU and memory, a plurality of storage devices 26 (e.g., hard disks), and a cache memory 27 for temporarily storing data transferred between these storage devices 26 and the NAS 10. The disk controller 25 manages the storage device 26 with the RAID (Redundant Arrays of Inexpensive Disks) system, and stores data in the corresponding storage device 26, or reads the designated data from the storage device 26 and transmits this to the NAS 10 according to the data I/O request provided from the NAS 10.

(1-2) Data Format of Packets

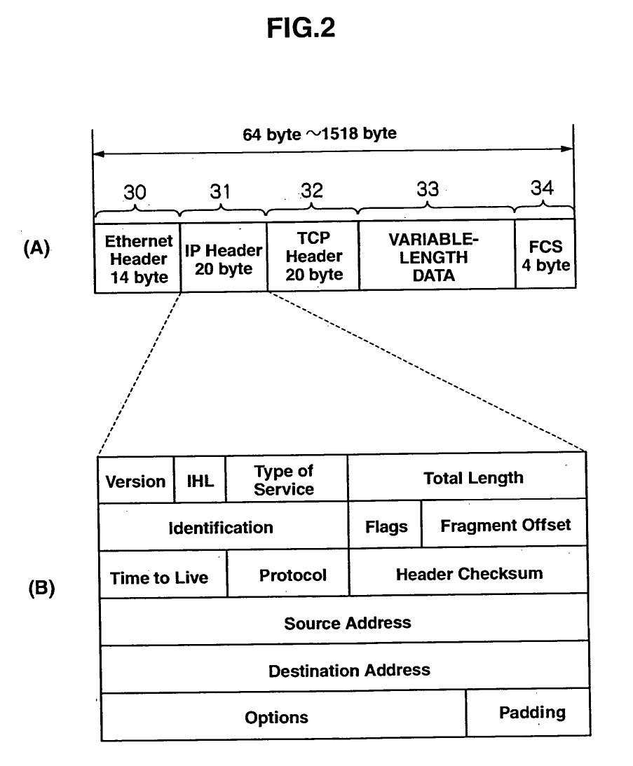

FIG. 2 is a diagram showing the data format of a packet to be transmitted and received between the client terminal 2, management terminal 3 or backup server 4 and the storage system 7. As evident from FIG. 2(A), this packet is configured by a 20 byte TCP header 32, 20 byte IP header 31 and 14 byte Ethernet (registered trademark) header 30 being sequentially added to the forefront of the variable-length data 33 constituted from data to be read from and written in the storage device 26 in the storage system 7 and various commands such as the data I/O request, as well as by a 4 byte FSC (Frame Check Sequence) data 34, which is data for detecting errors, being added next to the variable-length data 33. The size of the packet is prescribed within the range of 64 bytes to 1518 bytes, and data exceeding this range (data stored in the field of the variable-length data 33) is divided into a plurality of frames, and each frame is similarly packetized.

The IP header 31 has a data format as shown in FIG. 2(B). The version field (Version), header length field (IHL), TOS field (Type of Service) and packet length field (Total Length) respectively store the IP protocol version (normally “4”), length of the IP header 31 in 4 [byte] units (normally “5”), service content requested by such IP packet (portion constituted by the IP header 31, TCP header 32 and variable-length data 33), and overall length of the IP packet including the IP header 31 and TCP header 32. Further, the identification number field (Identification), flag field (Flags) and fragment offset field (Fragment Offset) respectively store the unique identification number of the original data divided into a plurality of frames, a flag representing whether the frame stored in such IP packet is the final frame of the original data, and data representing the position of the frame stored in such IP packet in the original data.

TTL field (Time to Live), protocol field (Protocol) and header checksum field (Header Checksum) store the duration of the respective IP packets, the port number of the upper layer protocol in which the IP packet was encapsulated, or data for detecting errors of the IP header 31. Further, the source IP address field (Source Address) and destination IP address field (Destination Address) store the source address or destination address of the respective IP packets. Moreover, the option field (Option) and padding field (Padding) store option data for designating special processing, or adjustment dummy data for making the header length of the IP header 31 a 32 bit integral multiple when using the option.

With the IP protocol having this kind of header configuration, 8 bits are assigned to the TOS field (Type of Service), and it is prescribed that the priority (precedence) of the IP packet can be set using the high 3 bits. Here, the larger the high 3 bit value, the higher the priority of the IP packet.

Thus, each time the foregoing first to third routers 5A to 5C (FIG. 1) equipped with the QoS function receive this packet 30, they preferentially perform transfer processing to the packet 30 with a higher priority based on the high 3 bit value of the TOS field of such packet 30; that is, the priority (0 to 7) set in the packet 30.

(2-3) Priority Processing Function and Priority Setting Function in NAS 10

Next, the priority processing function and priority setting function provided to the NAS 10 according to the present embodiment are now explained. The NAS 10 according to the foregoing present embodiment is equipped with a priority processing function of preferentially processing a packet with a greater priority (precedence) stored in the TOS field (“Type of Service” of FIG. 2(B)) of the IP header 31 of each packet, and a priority setting function of setting, upon transmitting the processing result to the client terminal 2, management terminal 3 or backup server 4, the priority that is the same as the priority (precedence) set in the packet of such processing request in the packet storing the processing result.

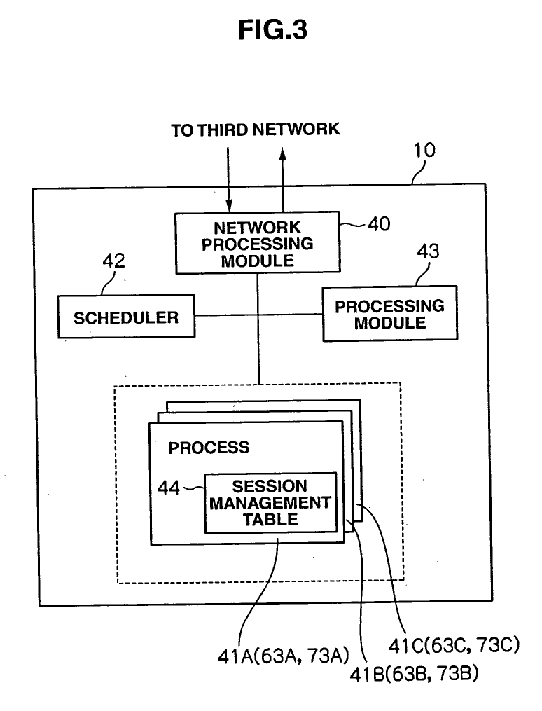

FIG. 3 is a diagram that functionally classifies the processing contents of the NAS 10 concerning such priority processing function and priority setting function. In FIG. 3, the network processing module 40 is a task that arises by the network interface 20 (FIG. 1) executing the program stored in its internal memory. Further, the processes 41A to 41C are processes that arise by the CPU 22 (FIG. 1) of the NAS 10 reading the corresponding program stored in the local disk 23 (FIG. 1) and deploying and executing this in the local memory 21 (FIG. 1). These processes 41A to 41C correspondingly exist in the respective the upper layer protocols compatible with the NAS 20 such as HTTP (Hypertext Transfer Protocol), FTP (File Transfer Protocol) and Telnet (Telecommunication network). The scheduler 42 and processing module 43 are tasks that arise by the CPU 22 reading the corresponding program stored in the local disk 23, and deploying and executing this in the local memory 21.

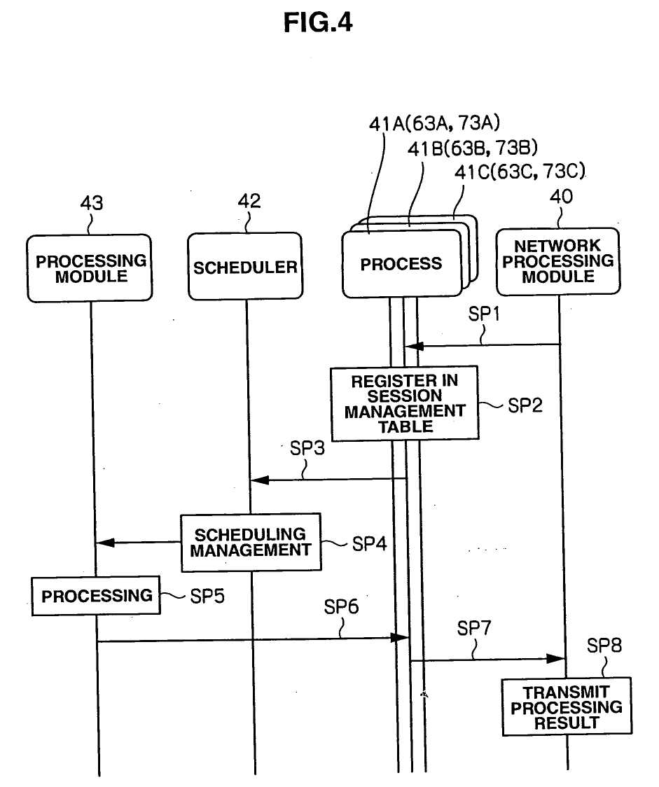

With the NAS 10 according to the present embodiment, the network processing module 40, respective processes 41A to 41C, scheduler 42 and processing module 43 respectively execute the necessary processing according to the processing steps shown in FIG. 4 so as to exhibit the foregoing priority processing function and priority setting function as the overall NAS 10.

In other words, in the case of the NAS 10, when the network processing module 40 receives the packet of data I/O request, write target data, or various commands from the client terminal 2, management terminal 3 or backup server 4, it detects the upper layer protocol based on the protocol contained in the variable-length data 33 (FIG. 2(A)) of the packet, and sorts the packets into the corresponding processes 41A to 41C based on the detection results (FIG. 4; SP1).

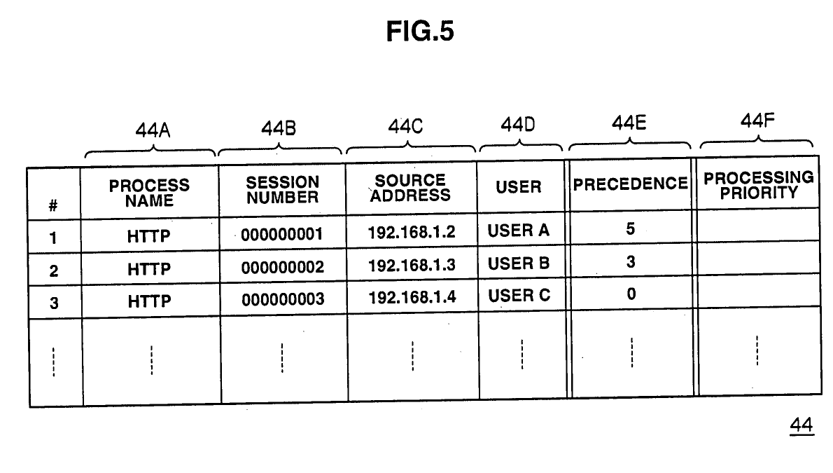

The processes 41A to 41C respectively create and retain the session management table 44 shown in FIG. 5 in the local memory 21 (FIG. 1). This session management table 44 is a table for managing the sessions sorted to itself, and is configured from a “process name” column 44A, a “session number” column 44B, a “source address” column 44C, a “user name” column 44D, a “priority (precedence)” column 44E and a “processing priority” column 44F.

And, when the processes 41A to 41C are provided with a packet of a new session from the network processing module 40, they store the protocol name of the upper layer protocol such as HTTP, NFS associated with itself in the “process name” column 44A. Further, the processes 41A to 41C store the serial number in the “session number” column 44B of the session management table 44. Moreover, the processes 41A to 41C read the source address from the source address field (“Source Address” of FIG. 2(B)) of the IP header 31 (FIG. 2(A) of the packet, and read the user name when it is stored in the variable-length data 33 of the packet, and respectively store these in the “source address” column 44C and “user name” column 44D of the session management table 44. As described above, the processes 41A to 41C register the session in the session management table 44.

Further, each of the processes 41A to 41C has a TOS mapping table 45 as shown in FIG. 6 read from the local disk 23 (FIG. 1) and stored in the local memory 21 (FIG. 1). This TOS mapping table 45 is a table associated to the packets regarding in what priority they should be processed in the NAS 10 in relation to the priority (precedence) of the packet set using the high 3 bits of the TOS field (“Type of Service” of FIG. 2(B)) of the foregoing IP header 31 contained in the packet.

For instance, in the example of FIG. 6, in the case of only “0”, “3” or “5” able to be set as the priority (precedence) in the packet, when the priority (precedence) set in the packet is “0” (i.e., priority (precedence) is not set), “0” is associated as the priority of processing (hereinafter referred to as the “processing priority”) of such packet in the NAS 10. Further, in the example of FIG. 6, when the priority (precedence) set in the packet is “3”, “1” is associated as the processing priority of such packet in the NAS 10, and, when the priority (precedence) set in such packet is “5”, “2” is associated as the processing priority of such packet in NAS 10.

When the processes 41A to 41C register a new session in the session management table 44 as described above, they detect the priority (precedence) set in the packet based on the high 3 bits of data stored in the TOS field of the IP header 31 in the packet subsequently received in the new session. Further, the processes 41A to 41C convert the detected priority (precedence) into a processing priority of the packet based on the TOS mapping table 45. The processes 41A to 41C then respectively store the priority set in the packet and the processing priority obtained based thereon in the “priority (precedence)” column 44E and “processing priority” column 44F of the session management table 44 so as to set these in such packet (FIG. 4; SP2).

FIG. 7 is a diagram showing the specific processing steps of the setting processing of such priority and processing priority. When the processes 41A to 41C finish storing the session number, source address and user name regarding the new session in the session management table 44, they foremost determine whether a priority (precedence) is set in the packet received in such session according to the priority and processing priority setting processing step RT1 illustrated in FIG. 7 (SP10).

If the processes 41A to 41C obtain a positive result from the determination (SP10: YES), they convert the priority (precedence) into a processing priority based on the TOS mapping table 45 (FIG. 6), and set this mapping result in the “processing priority” column 44F of the session management table 44 (FIG. 5). Further, together with this, the processes 41A to 41C set the priority (precedence) set in the packet in the “priority (precedence)” column 44D of the session management table 44 without change (SP11).

Contrarily, when the process 41A to 41C obtain a negative result from the determination (SP10: NO), they set “0” in both the “processing priority” column 44F and “priority (precedence)” column 44E of the session management table 44 (SP12).

Further, when the processes 41A to 41C finish setting the priority and processing priority as described above, they subsequently send the process name, session number and processing priority respectively stored in the “process name” column 44A and “session number” column 44B and “processing priority” column 44F of the session management table 44 to the scheduler 42 (FIG. 3) together with the processing request of such packet (FIG. 4; SP3).

The scheduler 42 schedules the processing of these packets in the order according to the processing priority set therein regarding the processing request of the respective packets provided form each of the processing modules 41A to 41C (FIG. 4; SP4).

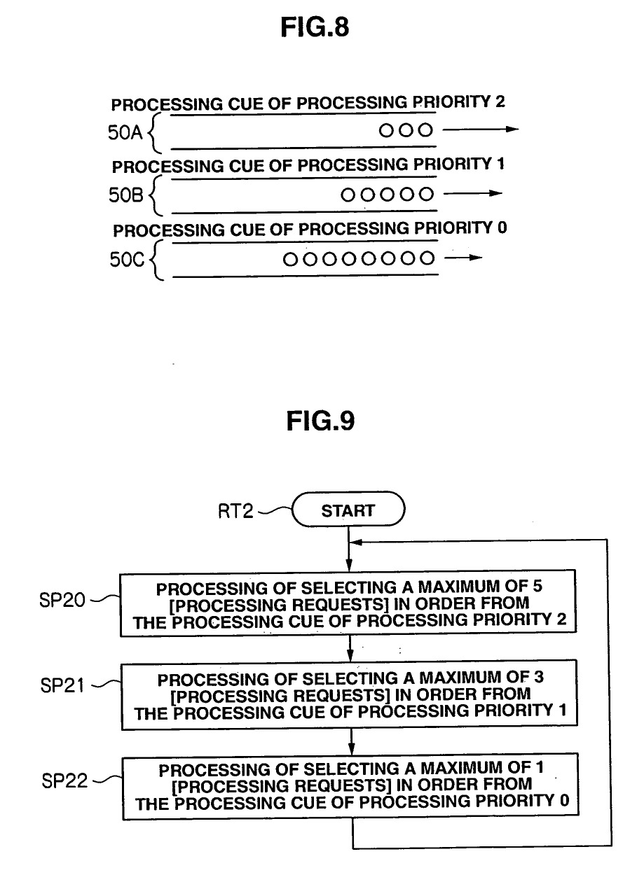

Specifically, the scheduler 42, as shown in FIG. 8, has processing cues 50A to 50C for each processing priority. When the scheduler 42 receives a processing request of a packet from the processes 41A to 41C, it sorts the processing request to the corresponding processing cue 50A to 50C based on the processing priority set in the packet.

Further, in parallel with the sorting processing, the scheduler 42 requests the processing module 43 to process the respective packets to which the processing request was sorted into the corresponding processing cues 50A to 50C according to the scheduling processing step RT2 shown in FIG. 9. In other words, the scheduler 42 foremost selects up to a maximum of 5 processing requests, for instance in the order received, from the respective processing requests sorted to the processing cue 50A having the largest processing priority of “2.” in the present embodiment, and sends these to the processing module 43 (SP20).

Moreover, the scheduler 42 thereafter selects up to a maximum of 3 processing requests, for instance in the order received, from the respective processing requests sorted to the processing cue 50B having a processing priority of “1”, and sends these to the processing module 43 (SP21). In addition, the scheduler 42 thereafter selects up to a maximum of 1 processing request, for instance in the order received, from the respective processing requests sorted to the processing cue 50C having a processing priority of “0”, and sends this to the processing module 43 (SP22). Then the scheduler 42 repeats similar processing (SP20 to SP22-SP20). As described above, the scheduler 42 requests the processing module 43 to process these packets in the order according to the processing priority set in such packets regarding each of the packets to which a processing request was made.

Meanwhile, the processing module 43 makes an inquiry on the processing content to the corresponding processes 41A to 41C based on the process name and session number provided together with the processing request regarding the respective processing requests provided from the scheduler 42, and executes the designated processing (e.g. I/O processing of data to and from the disk sub system 11 (FIG. 1)) (FIG. 4; SP5). Further, the processing module 43 sends this processing result (e.g., a completion notice, including the read data when the processing requests the readout of data) to the corresponding processes 41A to 41C (FIG. 4; SP6).

When the processing result is provided to the processing module 43, the processes 41A to 41C sends this processing result to the network processing module 40 together with the priority (precedence) of the packet stored in the session management table 44 (FIG. 4; SP7).

The network processing module 40 packetizes the processing result of the packet provided from the processes 41A to 41C. Thereupon, the network processing module 40 sets the priority (precedence) provided from the processes 41A to 41C together with the processing result in the TOS field (“Type of Service” of FIG. 2(B)) of the IP header 31 (FIG. 2(A)) of the packet storing the processing result. Then, the network processing module 40 transmits the packet of the processing result obtained as described above to the corresponding client terminal 2, management terminal 3 or backup server 4 (FIG. 4; SP8).

As described above, with the network system 1 according to the present embodiment, since the processing of the packets transmitted from the client terminal 2, management terminal 3 or backup server 4 to the NAS 10 is performed via scheduling based on the priority (precedence) set in such packet, processing may be performed with the priority (precedence) set in the respective packets even in the NAS 10. Further, since this network system 1 packetizes the processing results of the processing to such packets into a packet having the same priority (precedence) as the priority (precedence) set in such packet and sends this to the corresponding client terminal 2, management terminal 3 or backup server 4, the processing result of a packet having high priority can be preferentially subject to transfer processing in the first to third routers 5A to 5C.

Therefore, with this network system 1, packets to be preferentially processed can be preferentially processed during the transfer from the client terminal 2 or the like to the NAS 10, during the processing in the NAS 10, and during the transfer from the NAS 10 to the client terminal 2 or the like. Thus, this network system 1 is able to prevent the delay in transmission of important data or loss of such important data beforehand and effectively, and, as a result, a highly reliable network system can be created thereby.

### (2) Second Embodiment

Reference numeral 60 in FIG. 1 represents the network system according to the second embodiment. This network system 60 has the same configuration as the network system according to the first embodiment excluding the point that, with respect to packets without any setting of priority (precedence), the processing priority can be arbitrarily set in the NAS 61, and the processing result of such packet can be packetized into a packet having a priority according to the processing priority and sent from the NAS 61 to the corresponding client terminal 2 or the like.

Actually, in the case of the network system 60, the local disk 62 of the NAS 61 stores data of the priority list 64 as shown in FIG. 10. This priority list 64 is a list for setting the attributes of packets to be preferentially processed in the NAS 61. In the present embodiment, “user name”, “source address”, “type of protocol” and “type of process” may be set as the attributes, and a “user” column 64A, a “source address” column 64B, a “protocol” column 64C, a “process” column 64D and a “processing priority” column 64E are associated with these attributes and provided to the priority list 64.

And, in the priority list 64, the attributes (“user name”, “source address”, “type of protocol” and “type of process”) of the packet to be preferentially processed set by the system administrator of the storage system (FIG. 1) in advance using the management terminal 3 (FIG. 1) are respectively described in the corresponding “user” column 64A, “source address” column 64B, “protocol” column 64C or “process” column 64D. Moreover, in the priority list 64, the processing priority set by the system administrator in relation to the packet of such attributes is described in the corresponding “processing priority” column 64E.

For instance, in the example of FIG. 10, as the first setting (“#1”) of the priority list 64, “1” is set as the processing priority for processing the packet having a source address of “192.168.1.0/24”, and as the second setting (“#2”) of the priority list, “2” is set as the processing priority for processing the packets having a user name of “user A”. In this example, as the third setting (“#3”) of the priority list, “1”, is set as the priority for processing packets where the upper layer protocol is “NFS”, and as the fourth setting (“#4”) of the priority list, “2” is set as the processing priority for processing the packets having a source address of “192.168.2.0/24” and where the process is “samba”. Incidentally, for instance, for those that are not urgent, such as the transfer request or the like of backup data from the backup server 4, by setting the processing priority low, it will be possible to effectively prevent the processing delay of important data or data which should be processed in real time, or the loss thereof.

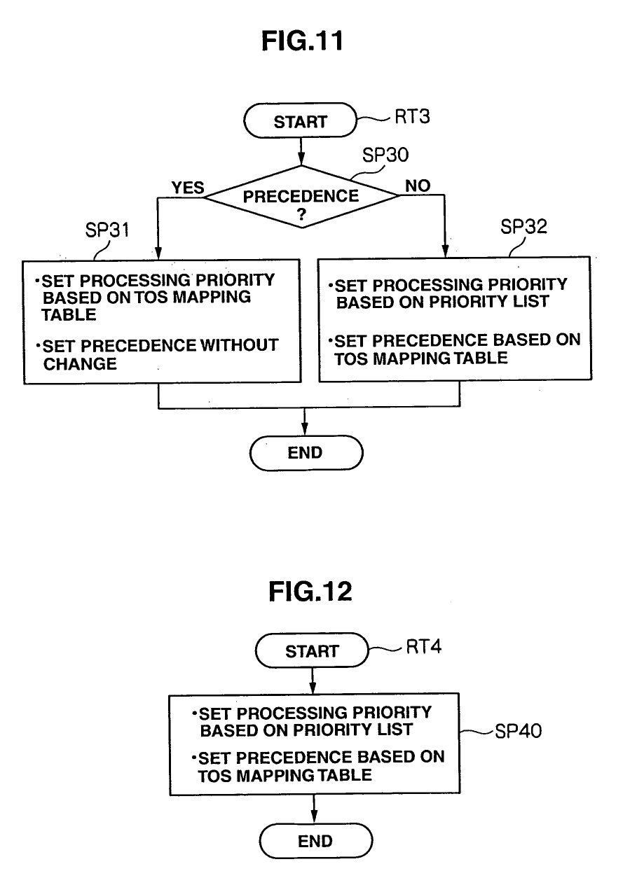

When starting, at the NAS 61, data of this priority list 64 is read out from the local disk 62 (FIG. 1) and stored in the local memory 21 together with data such as the TOS mapping table 45 described with reference to FIG. 6. When each of the processes 63A to 63C (FIG. 3) according to this second embodiment similar to the processes 41A to 41C described with reference to FIG. 3 receives a packet sent from the client terminal 2, management terminal 3 or backup server 4 from the network processing module 40, it executes the setting processing of priority (precedence) and processing priority to the session management table 44 described with reference to step SP2 of FIG. 4 according to the priority and processing priority setting processing step RT3 shown in FIG. 11 based on this priority list 64.

In other words, when each of the processes 63A to 63C receives the packet from the network processing module 40, it foremost determines whether a priority (precedence) is set in the packet based on the high 3 bit value of data stored in the TOS field of the IP header 31 (FIG. 2(A)) of the packet (SP30).

If the processes 63A to 63C obtain a positive result from the determination (SP30: YES), they convert the priority (precedence) into a processing priority based on the TOS mapping table 45 (FIG. 6), and set this mapping result in the “processing priority” column 44F of the session management table 44 described with reference to FIG. 5. Further, together with this, the processes 63A to 63C set the priority (precedence) set in the packet in the “priority (precedence)” column [44D] of the session management table 44 without change (SP31).

Contrarily, when the process 63A to 63C obtain a negative result from the determination (SP30: NO), they extract the user name and type of process of the session (e.g., “samba”) from the variable-length data (FIG. 2(A)) of the packet. Further, together with this, the processes 63A to 63C extract the source address of the packet from the source IP address field (“Source Address” of FIG. 2(B)) of the IP header (FIG. 2(A)) of the packet, and further extract the upper layer protocol (HTTP, FTP, Telnet, etc) from the port number stored in the protocol field (“Protocol” of FIG. 2(B)) of the IP header 31.

Next, the processes 63A to 63C refer to the priority list 64 and determine whether any of the attributes among user name, type of process, source address and the upper layer protocol extracted from such packet is registered in the priority list 64. When none of the attributes is registered is in the priority list 64, the processes 63A to 63C store “0” in the “processing priority” column 44F and “priority (precedence)” column 44E of the session management table 44 (FIG. 5).

Contrarily, when any one of these attributes are registered in the priority list 64, the processes 63A to 63C reads the processing priority set in advance with respect to such attribute from the corresponding “processing priority” column 64E of the priority list 64. Thereupon, a priority level was set to these attributes in advance, and processes 63A to 63C read the processing priority set in advance to one of the attributes assigned a high priority level when the attributes included in the packet are duplicate.

And, when the processes 63A to 63C read the corresponding processing priority from the priority list 64 as described above, the store this in the “processing priority” column 44F of the session management table 44. Further, the processes 63A to 63C convert the processing priority of the packet read out from the priority list 64 into the priority (precedence) with the TOS mapping table 45 (FIG. 6), and store the conversion result in the “priority (precedence)” column 44E of the session management table 44 (SP32).

Thereafter, the processes 63A to 63C end the setting processing (FIG. 4; SP2) of the priority (precedence) and processing priority in relation to the session management table 44, and thereafter send (FIG. 4; SP3) the session number, type of process and processing priority of the packet, together with the processing request of such packet, respectively stored in the “session number” column 44A, “process” column 44B and “processing priority” column 44F of the session management table 44 to the scheduler 42 (FIG. 3).

Accordingly, even in cases when the priority (precedence) is not set in the packet transmitted from the client terminal 2 or the like to the NAS 61, if such packet has the attributes (“user name”, “source address”, “type of protocol” and “type of process”) registered in the priority list 64, since the processing priority stored in the priority list 64 regarding such attribute is provided to the scheduler 42, this packet will be processed with the protocol module 43 (FIG. 3) based on such processing priority.

Moreover, when the processing result of the packet is provided to the processing module 43, the processes 63A to 63C transmit the processing result to the network processing module 30 (FIG. 3) together with the priority (precedence) described in the “priority (precedence)” column 44E of the packet of the session management table 44 (FIG. 4; SP7).

Then, the network processing module 40 packetizes the processing results of the session provided from the processes 63A to 63C. Thereupon, the network processing module 40 sets the priority (precedence) provided from the processes 63A to 63C together with the processing result in the high 3 bits of the TOS field (“Type of Service” of FIG. 2(B)) of the IP header 31 (FIG. 2(A)) of the packet of such processing result. Then, the network processing module 40 sequentially transmits the packet of the processing result obtained as described above to the corresponding client terminal 2, management terminal 3 or backup server 4 (FIG. 4; SP8).

As described, with the network system 60 according to the present embodiment, as a result of registering the desired attributes (“user name”, “source address”, “type of protocol” and “type of process”) and the processing priority in the priority list 64 of the NAS 61, the processing of the packet having such attributes in the NAS 61 can be performed based on the set processing priority. Therefore, in comparison to the network system 1 of the first embodiment, this network system 60 is able to set the priority of processing in the NAS 61 in detail.

Further, with this network system 61, although a priority is not set, since the priority (precedence) according to the processing priority registered in the priority list 64 is set in the packet upon transmitting the processing result of the packet having the attributes registered in the priority list 64 from the NAS 61 to the corresponding client terminal 2 or the like, this packet can be preferentially subject to transfer processing in the first to third routers 5A to 5C. Accordingly, it will be possible to prevent the delay in transmission of data or loss of such data upon distributing data of users registered in advance from the NAS 71 to the client terminal thereof beforehand and effectively.

### (3) Third Embodiment

In FIG. 1, reference numeral 70 represents the overall network system according to the third embodiment. This network system 70 is configured similarly to the network system 60 according to the second embodiment excluding the point that, even in cases when the priority (precedence) is set in the packet transmitted from the client terminal 2, management terminal 3 or backup server 4 to the NAS 71, the processing priority can be set in such packet according to the priority list (FIG. 10) retained by the NAS 71.

Actually, in the case of this network system 70, the NAS 71 is retaining the data of the priority list 64 described above with reference to FIG. 10 in the local disk 72 (FIG. 1). Data of this priority list 64 is read from the local disk 72 together with the data of the TOS mapping table 45 (FIG. 6) upon the activation of the NAS 71, and stored in the local memory 21 (FIG. 1).

And when each of the processes 73A to 73C (FIG. 3) according to this third embodiment similar to the processes 41A to 41C described with reference to FIG. 3 receives the packet transmitted from the client terminal 2, management terminal 3 or backup server 4 from the network processing module 40, it executes the setting processing of the priority (precedence) and processing priority to the session management table 44 described in step SP2 of FIG. 4 with this priority list 64 according to the priority and processing priority setting processing step RT4 illustrated in FIG. 12.

In other words, when each of the processes 73A to 73C receives the packet from the network processing module 40, similar to step SP32 of FIG. 11, it stores the processing priority and priority of that packet (session) in the “processing priority” column 44F and “priority (precedence)” column 44E of the session management table 44 (SP40).

Thereafter, the processes 73A to 73C end the setting processing (FIG. 4; SP2) of the priority (precedence) and processing priority of the session management table 44, and send the session number, type of process and processing priority of the packets respectively stored in the “session number” column 44A, “process” column 44B and “processing priority” column 44F of the session management table 44 to the scheduler 42 (FIG. 3) together with the processing request of such packet (FIG. 4; SP3).

Therefore, even when a priority (precedence) is set in the packet transmitted from the client terminal 2 or the like to the NAS 71, if such packet has the attributes (“user name”, “source address”, “type of protocol” and “type of process”) registered in the priority list 64, since the processing priority registered in the priority list 64 regarding such attributes is provided to the scheduler 42, such packet will be processed with the protocol module 43 (FIG. 4) based on this processing priority.

Further, when the processing result of the packet is provided to the processing module 43, the processes 73A to 73C transmit the processing result thereof to the network processing module 40 (FIG. 3) together with the priority (precedence) described in “priority (precedence)” column 44E of the packet of the session management table 44 (FIG. 4; SP7).

Thus, the network processing module 40 packetizes the processing results of the packets provided from these processes 73A to 73C. Thereupon, the network processing module 40 sets the priority (precedence) provided from the processes 73A to 73C together with these processing results in the high 3 bits of the TOS field (“Type of Service” of FIG. 2(B)) of the IP head 31 (TOS field of FIG. 2(A)) of the packet of such processing result. And, the network processing module 40 sequentially transmits the packet of the processing result obtained as described above to the corresponding client terminal 2, management terminal 3 or backup server 4 (FIG. 4; SP8).

As described above, with the network system 70 according to the present embodiment, even in cases where a priority (precedence) is set in the packet, when such packet has the attributes (“user name”, “source address”, “type of protocol” and “type of process”) registered in the priority list 64 of the NAS 71, these are processed in the NAS 71 based on the processing priority set in the priority list 64. Thus, with this network system 70, for instance, although a high priority (precedence) will be set, even when a packet having an attribute not registered in the priority list 64 is provided to the NAS 71, it is possible to preferentially process in the NAS 71 the packet having the attribute registered in the priority list 64. Accordingly, although a high priority (precedence) is set, even when a large number of packets having an attribute not registered in the priority list 64 are provided to the NAS 71, it will be possible to reliably prevent the processing of a specific packet being delayed, or the data stored in such packet being lost.

Further, with this network system 70, upon transmitting the processing result of the packet having an attribute registered in the priority list 64 from the NAS 71 to the corresponding client terminal 2 or the like, since the priority (precedence) according to the processing priority registered in the priority list 64 is set in such packet, this packet can be preferentially subject to transfer processing in the first to third routers 5A to 5C. Accordingly, it will be possible to prevent the delay in transmission of data or loss of such data upon distributing data of users registered in advance from the NAS 71 to the client terminal 2 beforehand and effectively.

### (4) Other Embodiments

Incidentally, in the first to third embodiments described above, although a case of configuring the present invention as NAS was explained, the present invention is not limited thereto, and, for instance, the NAS function may be provided to the storage sub system 11, and the present invention may be used in such storage sub system 11.

Further, in the second and third embodiments described above, although a case was explained where four attributes of “user name”, “source address”, “type of protocol” and “type of process” were used as the attribute of the packet registerable in the priority list, the present invention is not limited thereto, and other attributes may also be used.

In addition to NAS, the present invention may also be broadly used in various storage systems.

We claim:

1. A storage system for packetizing and transmitting/receiving information with a host system, comprising:
a first processing unit for detecting the priorities respectively set to each packet to be transmitted from said host system;
a second processing unit for processing each of said packets; and
a communication unit for packetizing the processing results of each of said packets into a packet having the same priority as said priorities set to said packets, and transmitting this to said host system.

2. A storage system according to claim 1,
wherein said first processing units are respectively provided in correspondence with each the upper layer protocol; and
said communication unit sorts each of said packets transmitted from said host system to respectively corresponding said first processing units.

3. A storage system according to claim 1,
wherein said first processing unit has a mapping table in which said priority set in said packet and the processing priority are associated in advance, and uses said mapping table to convert said priority set in each of said packets transmitted from said host system into said processing priority, and set said converted processing priority in said packet.

4. A storage system according to claim 1,
wherein said first processing unit sets the processing priority of said packet based on said detected priority of said packet, and includes a scheduling unit for scheduling the processing order of said packet based on said processing priorities respectively set to each of said packets; and
said second processing unit processes each of said packets respectively according to said processing order scheduled with said scheduling unit.

5. A storage system according to claim 4,
wherein said scheduling unit sorts the processing requests of each of said packets into the corresponding processing cues among said processing cues provided to each of said processing priorities based on said processing priorities respectively set to each of said packets, and preferentially processes said packet belonging to said processing cue in which said processing request having a high processing priority.

6. A storage system according to claim 4,
wherein said first processing unit has a priority list in which said processing priority of said packet having a desired attribute is prescribed in advance; and
when said packet provided from said host system has said attribute registered in said priority list, it sets said processing priority to said packet according to said priority list.

7. A storage system according to claim 6,
wherein, when said priority is not set in said packet transmitted from said host system and said packet has said attribute registered in said priority list, said first processing unit sets said processing priority to said packet according to said priority list.

8. A storage system according to claim 6,
wherein, even when said priority is set to said packet transmitted from said host system, if said packet has said attribute registered in said priority list, said first processing unit sets said processing priority to said packet according to said priority list.

9. A data processing method in a storage system for packetizing and transmitting/receiving information with a host system, comprising:
a first step for detecting the priorities respectively set to each packet to be transmitted from said host system;
a second step for processing each of said packets; and
a third step for packetizing the processing results of each of said packets into a packet having the same priority as said priorities set to said packet, and transmitting this to said host system.

10. A data processing method according to claim 9,
wherein, at said first step,
the respective packets transmitted from said host system are respectively sorted to the processing systems respectively corresponding to each the upper layer protocol, and said priority set to said packet for each of said processing systems is detected.

11. A data processing method according to claim 9,
wherein, at said first step,
a mapping table in which said priority set in said packet and the processing priority are associated in advance is used to convert said priority set in each of said packets transmitted from said host system into said processing priority, and set said converted processing priority to said packet.

12. A data processing method according to claim 9,
wherein, at said first step,
the processing priority of said packet is set based on said detected priority of said packet; and
said second step includes:
a scheduling step for scheduling the processing order of said packet based on said processing priority respectively set to each of said packets; and
a processing step for respectively processing each of said packets according to said scheduled processing order.

13. A data processing method according to claim 12,
wherein, at said scheduling step,
the processing requests of each of said packets are sorted into the corresponding processing cues among said processing cues provided to each of said processing priorities based on said processing priorities respectively set to each of said packets, and scheduling is performed to preferentially process said packet belonging to said processing cue in which said processing request having a high processing priority.

14. A data processing method according to claim 12,
wherein, at said first step,
a priority list in which said processing priority of said packet having a desired attribute is prescribed in advance is used to set said processing priority to said packet according to said priority list when said packet provided from said host system has said attribute registered in said priority list.

15. A data processing method according to claim 14,
wherein, at said first step,
when said priority is not set in said packet transmitted from said host system and said packet has said attribute registered in said priority list, said processing priority is set to said packet according to said priority list.

16. A data processing method according to claim 14,
wherein, at said first step,
even when said priority is set to said packet transmitted from said host system, if said packet has said attribute registered in said priority list, said processing priority is set to said packet according to said priority list.
